(19) United States
(12) Patent Application Publication
(10) Pub. No.: US 2026/0121781 A1
(43) Pub. Date: Apr. 30, 2026

(54) SYSTEMS AND METHODS FOR ACTIVATING MULTI-RATE OPTICAL NETWORK UNITS IN OPTICAL NETWORKS

(71) Applicant: Adtran, Inc., Huntsville, AL (US)

(72) Inventors: Richard Goodson, Huntsville, AL (US); Martin Kuipers, Dallgow-Doberitz (DE)

(73) Assignee: Adtran, Inc., Huntsville, AL (US)

(21) Appl. No.: 19/375,995

(22) Filed: Oct. 31, 2025

Related U.S. Application Data
(60) Provisional application No. 63/714,619, filed on Oct. 31, 2024.

(51) Int. Cl. H04J 14/02

(52) U.S. Cl. CPC H04J 14/026; H04J 14/0245

(57) ABSTRACT

A system for activating multi-rate optical network units (ONUs) includes an optical network having an optical line terminal (OLT) optically coupled to a plurality of ONUs, including one or more multi-rate ONUs configured to support multiple upstream rates. During discovery when other ONUs are permitted to transmit in the same quiet window, a multi-rate ONU that supports a higher rate is instead configured to send a discovery response at a sufficiently low rate so as not to require training of an equalizer, thereby allowing for a short preamble for the discovery response. Thereafter, during a quiet window for ranging when only the multi-rate ONU will be transmitting to prevent data collisions, the multi-rate ONU is transitioned to a higher rate and transmits a message with a sufficiently long preamble to train an equalizer at the OLT.

### CROSS REFERENCE TO RELATED APPLICATION

This application claims priority to U.S. Provisional Application No. 63/714,619, entitled “G.9804.2 Considerations for Multi-Rate ONUs” and filed on Oct. 31, 2024, which is incorporated herein by reference.

### RELATED ART

Passive optical networks (PONs) are used extensively in telecommunication systems to provide high-speed optical communications between an optical line terminal (OLT) and a plurality of optical network units (ONUs). Each ONU typically shares a common optical fiber for communication with the OLT, and upstream communications from the ONUs to the OLT are often time-division multiplexed. It is generally desirable for communication through the PON to be highly efficient and robust in order to enhance the PON's performance (e.g., increase data throughput and reduce latency).

To transmit upstream data from the ONU to the OLT through the PON, the OLT must first activate the ONU by discovering and then ranging the ONU. In the discovery process, the OLT requests the ONU to send to the OLT a discovery message that includes an identifier (e.g., serial number) of the ONU and a list of rates the ONU supports. After discovering the presence of the ONU on the optical network, the OLT enters the ranging process by requesting the ONU to send a ranging message that allows the OLT to measure the exact round-trip delay between the OLT and the ONU. Once the ONU has been discovered and ranged, the OLT begins to allocate upstream timeslots to the ONU for data communication. An ONU that has completed the discovery and ranging processes to enable communication with the OLT is typically referred to as “activated.” An ONU that has yet to complete such discovery and ranging processes and, thus, is unable to transmit upstream data to the OLT may be referred to as “unactivated.”

The discovery process for discovering unactivated ONUs is typically implemented from time-to-time in certain time windows, often referred to as “quiet windows,” in which activated ONUs are not allocated upstream timeslots by the OLT and, thus, are prevented from transmitting to the OLT. Near the time of a quiet window, the OLT broadcasts a message, referred to herein as a “discovery request,” across the PON to indicate that any unactivated ONU hearing the discovery request may attempt to send a message, referred to herein as a “discovery response,” in the quiet window for enabling the OLT to discover the presence of the ONU on the PON, as described above. Such a discovery request and discovery response are sometimes referred to as a “serial number grant” and a “serial number ONU message,” respectively. Noting that multiple unactivated ONUs may attempt to send a discovery response during the same quiet window, the unactivated ONUs may employ timing backoff algorithms in an effort to randomize the times at which they transmit discovery responses during the quiet window to reduce the likelihood of data collisions.

For any discovery response received by the OLT, the OLT assigns an ONU identifier to the ONU that transmitted the discovery response and then transmits a message, referred to herein as an “assignment notification,” informing the ONU of its ONU identifier for the PON.

Once an ONU has been discovered and assigned an ONU identifier for the PON, a ranging process is performed in order to determine the round-trip transmission delay between the ONU and the OLT. Specifically, the OLT generates a quiet window for the ranging process, and during the ranging process, a ranging request and a ranging response are communicated by the OLT and the ONU so that the round-trip transmission delay between the OLT and the ONU can be calculated. Such a ranging request and ranging response are sometimes referred to as a “ranging grant” and a “Registration message,” respectively. After the ranging process, the activation of the ONU is complete, and the OLT begins allocating upstream timeslots to the ONU for data communication using a desired dynamic bandwidth allocation algorithm (DBA).

In this regard, according to the optical protocol of the PON, the transmissions across the PON are segmented into frames, and for each frame, the OLT uses a control channel of the PON to broadcast a bandwidth map that allocates timeslots of the frame among the ONUs. For each allocated timeslot, only one ONU is permitted to transmit upstream during the timeslot, thereby preventing data collisions. That is, the upstream channel is time-division multiplexed under the control of the OLT.

Some optical protocols may allow ONUs to transmit to the OLT at different rates. For example, Higher Speed PON (HSP), also known as International Telecommunication Union-Telecommunication Standardization Sector (ITU-T) G.9804.x, is a protocol for allowing ONUs to transmit upstream at multiple rates (e.g., 12.5 gigabits per second (Gbps), 25 Gbps, or 50 Gbps) depending on the capabilities of the OLT and ONUs connected to the PON. Allowing for multiple rates creates various complexities that can impact PON performance.

As an example, it is generally possible for an ONU to transmit at a sufficiently low rate, such as 25 Gbps, without the OLT using an equalizer to compensate for losses caused by optical dispersion as an optical signal propagates from the ONU to the OLT. However, at a higher date, such as 50 Gbps, it is often desirable for the OLT to use an equalizer, which must be trained to effectively compensate for transmission losses. In this regard, training typically involves the transmission from the ONU to the OLT of a relatively long training sequence that can be analyzed by the OLT's equalizer to discover the proper weighting coefficients for compensating for transmission losses.

If ONUs capable of transmitting at 50 Gbps (referred to hereafter as “50 G ONUs”) are permitted to transmit discovery responses in the same quiet window, then the likelihood of data collisions in the quiet window may be increased due to longer preambles used for the 50 G messages. In this regard, the discovery messages transmitted at 50 Gbps by 50 G ONUs may have a longer preamble to permit training of an equalizer at the OLT such that the transmission time of such messages is significantly increased, thereby increasing the chances of a data collision. To mitigate this increased risk of data collisions, the size of the quiet window may be increased. However, increasing the size of the quiet window has the drawback of usurping additional network bandwidth, thereby reducing the amount of overall time available for activated ONUs to communicate with the OLT. In addition, discovery delays introduced by the use of longer preambles may be particularly disadvantageous for delay critical applications.

It is also possible to define different quiet windows associated with different data rates. As an example, a first quiet window of a relatively short duration may be used by 25 G ONUs, and a second quiet window of a longer duration may be used by 50 G ONUs. However, such an approach undesirably divides the discovery process over more quiet windows, and at least some additional network bandwidth is usurped to accommodate the longer transmission times for discovery messages transmitted by the 50 G ONUs. Further, dividing discovery over multiple windows may increase discovery delays that could be particularly problematic for delay critical applications.

Improved techniques for efficiently activating ONUs capable of transmitting at multiple rates through an optical network are generally desired.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating an exemplary embodiment of a telecommunication system that employs an optical network.

FIG. 2 is a block diagram illustrating an exemplary embodiment of an optical line terminal, such as is depicted by FIG. 1.

FIG. 3 is a block diagram illustrating an exemplary embodiment of a controller, such as is depicted by FIG. 2, for controlling registration of optical network units and upstream communication in an optical network.

FIG. 4 is a block diagram illustrating an exemplary message communicated through an optical network, such as is depicted by FIG. 1.

### DETAILED DESCRIPTION

The present disclosure generally pertains to systems and methods for activating multi-rate optical network units (ONUs) in optical networks. In some embodiments, an optical network has an optical line terminal (OLT) in communication with a plurality of ONUs. One or more of the ONUs, referred to herein as “multi-rate ONUs,” are configured to support multiple upstream rates specified by an applicable standard (e.g., a standard promulgated by the International Telecommunication Union), including at least a first rate (“low rate”) and a second rate (“high rate”). During discovery, the participating ONUs are controlled to transmit at the low rate, including multi-rate ONUs that also support the high rate.

In some embodiments, the low rate used by the ONUs in the quiet window for discovery is sufficiently low so as not to require the use of an equalizer at the OLT to receive the discovery responses, and shorter preambles for the discovery responses may therefore be used. Using shorter preambles reduces the likelihood of data collisions in the quiet window, thereby increasing the likelihood that discovery responses will be successfully received and permitting the duration of the quiet window to be shortened, if desired. In addition, since any ONU capable of transmitting at the low rate (including ONUs also capable of transmitting at a higher rate) may respond during the quiet window, a higher number of ONUs (with relatively short preambles) are permitted to respond during the same quiet window helping to enhance the efficiency of the discovery process.

In transmitting a discovery response, each ONU is configured to include information indicating which data rates it supports. After discovering the presence of an ONU, the OLT uses information in the discovery response to determine whether the ONU supports a rate that is both higher than the one used in the quiet window and also supported by the OLT. If so, the OLT controls the ONU subsequent to discovery (e.g., during ranging and/or data communication) to transmit upstream at the higher rate. Notably, for such subsequent communication, such as during ranging, the multi-rate ONU may be configured to transmit a ranging response message with a sufficiently long preamble to enable training of the equalizer at the OLT. Thus, during discovery when other ONUs are permitted to transmit in the same quiet window, multi-rate ONUs capable of transmitting at the high rate instead send discovery responses at a lower rate allowing for shorter preambles, thereby helping to prevent data collisions and to issue shorter quiet windows. Thereafter, such as during ranging when only a single multi-rate ONU is allocated upstream timeslots for transmission, thereby preventing the occurrence of data collisions, the multi-rate ONU is transitioned to transmitting at a higher rate and may send a ranging response with a long preamble at a higher rate to enable training of the equalizer at the OLT.

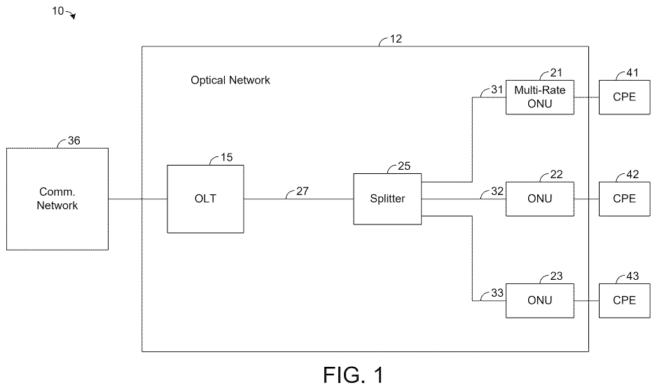

FIG. 1 depicts an exemplary embodiment of a telecommunication system 10 having an optical network 12. In some embodiments, the optical network 12 of FIG. 1 is a passive optical network (PON), but other types of optical networks are possible in other embodiments. As shown by FIG. 1, the optical network 12 has an optical line terminal (OLT) 15 that is optically coupled to a plurality of optical network units (ONUs) 21-23. For illustrative purposes, three ONUs 21-23 are shown in FIG. 1, but the optical network 12 may have number of ONUs 21-23 as may be desired.

As shown by FIG. 1, the OLT 15 is coupled to an optical splitter 25 by at least one optical fiber 27 shared by each on the ONUs 21-23 for communication with the OLT 15, and the splitter 25 is coupled to the ONUs 21-23 by optical fibers 31-33, respectively. As an example, the optical network 12 may form part of the telecommunication system 10 where the OLT 15 is positioned at a central office or an intermediate point between the central office and a plurality of customer premises. Each ONU 21-23 may be positioned at or near a respective customer premises. However, other locations of the OLT 15 and ONUs 21-23 and other uses and configurations of the optical network 12 are possible in other embodiments.

In the downstream direction, the OLT 15 is configured to receive data to be transmitted to the ONUs 21-23. As an example, the OLT 15 may receive data from a communication network 36, such as the Internet, public switched telephone network (PSTN), and/or some other type of network for communicating data. The OLT 15 is further configured to encapsulate the data in accordance with the optical protocol of the network 12 and to transmit the encapsulated data via at least one optical signal through the optical fiber 27 connected to the OLT 15. An optical data signal carrying data from the OLT 15 is split by the splitter 25 so that it is received by each of the ONUs 21-23. Each ONU 21-23 extracts at least a portion of the transmitted downstream data from the received signal and transmits the data, as appropriate, further downstream, such as to customer premises equipment (CPE) 41-43 at one or more customer premises or other types of communication devices.

In the upstream direction, each ONU 21-23 receives data to be communicated to the OLT 15. As an example, an ONU 21-23 may receive data from CPE 41-43 at one or more customer premises or other communication devices. The ONU 21-23 is further configured to encapsulate the data in accordance with the optical protocol of the network 12 and to transmit such data via at least one optical data signal through the respective optical fiber 31-33 connected to the ONU 21-23. The optical signals transmitted by the ONUs 21-23 pass through the splitter 25 and the optical fiber 27 and are received by the OLT 15. The OLT 15 extracts the transmitted upstream data and transmits the data, as appropriate, further upstream, such as to the network 36.

The downstream signal transmitted by the OLT 15 may be at a different wavelength than the wavelength or wavelengths of the upstream signals transmitted by the ONUs 21-23. In some embodiments, each ONU 21-23 transmits at the same wavelength, and communication in the upstream direction is time-division multiplexed, under the control of the OLT 15, so as to prevent interference between the transmissions of the ONUs 21-23. In this regard, as known in the art, the OLT 15 may communicate with the ONUs 21-23 via a control channel of the optical protocol of the network 12 and assign each ONU 21-23 with timeslots in which to transmit in the upstream direction according to a desired dynamic bandwidth allocation (DBA) algorithm.

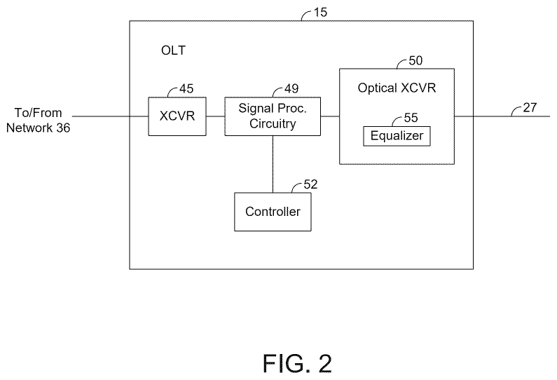

FIG. 2 depicts an embodiment of the OLT 15. As shown by FIG. 2, the OLT 15 has a transceiver 45 configured to receive a signal carrying data to be transmitted to the ONUs 21-23. Such data is processed by signal processing circuitry 49, which is configured to encapsulate the data in accordance with the optical protocol of the network 12. The encapsulated data is transmitted to an optical transceiver 50 that is optically coupled to the fiber 27. The optical transceiver 50 converts the data from the electrical domain to the optical domain and transmits an optical signal carrying the data through the optical fiber 27 to the ONUs 21-23.

In the upstream direction, the optical transceiver 50 receives an optical signal from the fiber 27 and converts the received signal from the optical domain to the electrical domain. The signal is then processed by the signal processing circuitry 49 for further upstream transmission through the transceiver 45 to the network 36 (FIG. 1). As shown by FIG. 2, the optical transceiver 50 may have an equalizer 55 that is configured to process the signal received from the optical fiber 27 in order to compensate for transmission distortions.

Note that it is unnecessary for the equalizer 55 to process all the signals received from the ONUs 21-23 depending on the data rates associated with the received signals. In this regard, errors resulting from optical dispersion generally increase with data rate. Thus, it is possible for a signal at a lower data rate to be adequately received with reasonable signal quality without processing by the equalizer 55 whereas, to achieve a similar signal quality, it may be desirable to use the equalizer 55 to process a signal transmitted at a significantly higher data rate. Before the equalizer 55 can be used to process a signal for compensating for transmission distortions, the equalizer 55 must first be trained in order to define a suitable set of weighting coefficients to be used to filter the signal. Training typically involves the transmission of a predefined string of values that the equalizer 55 then analyzes after the string has propagated through a data channel to learn the proper weighting coefficients to be applied to the signal in order to correct distortion that is introduced by the data channel.

As shown by FIG. 2, the OLT 15 has a controller 52 that is configured to manage the communication occurring over the optical network 12. As an example, the controller 52 may be configured to activate ONUs 21-23 and schedule upstream timeslots. In this regard, the controller 52 may communicate with the ONUs 21-23 via a control channel of the optical protocol of the network 12 or otherwise to determine traffic loads at the ONUs 21-23, allocate upstream timeslots to the ONUs 21-23 according to a desired DBA algorithm, and communicate a schedule of upstream timeslots (referred to as a “bandwidth map”) to the ONUs 21-23 so that each ONU 21-23 is aware of when it is permitted to transmit upstream to the OLT 15.

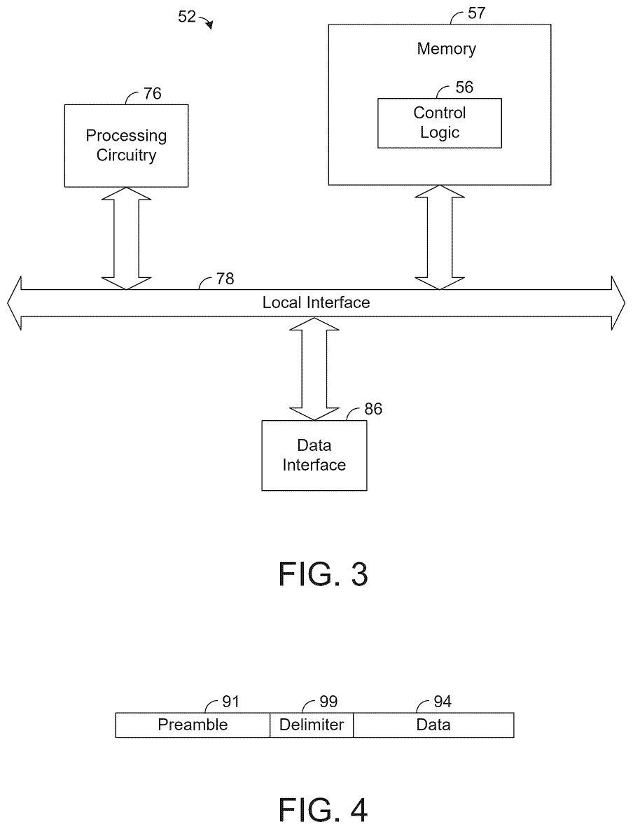

FIG. 3 depicts an exemplary embodiment of the controller 52. As shown by FIG. 3, the controller 52 comprises control logic 56 for generally controlling the operation of the controller 52, as will be described in more detail hereafter. The control logic 56 can be implemented in software, hardware, firmware or any combination thereof. In the controller 52 illustrated by FIG. 3, the control logic 56 is implemented in software and stored in memory 57.

Note that the control logic 56, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary controller 52 depicted by FIG. 3 comprises processing circuitry 76 (e.g., at least one conventional processor, such as a digital signal processor (DSP) or a central processing unit (CPU)) that communicates to and drives the other elements within the controller 52 via a local interface 78, which can include at least one bus. As an example, when the control logic 56 is implemented in software, the processing circuitry 76 may retrieve and execute instructions of such software. Further, a data interface 86, such as one or more data ports, may be used to communicate data with other components of the OLT 15.

As noted above, before an ONU 21-23 may communicate data with the OLT 15 over the optical network 12, it first must be activated by the OLT 15 by participating in a discovery process. Such a discovery process includes a quiet window that is scheduled by the controller 52 to occur from time-to-time, such as every second or at other frequency. For each quiet window, the controller 52 does not allocate upstream timeslots to any of the activated ONUs so that they do not attempt to communicate upstream, thereby allowing any unactivated ONU to attempt discovery with the OLT 15.

In some embodiments, one or more of the ONUs 21-23 may be a multi-rate ONU that is capable of transmitting upstream at different rates. FIG. 1 shows ONU 21 configured to be such a multi-rate ONU, but there may be any number of multi-rate ONUs in the network 12 for other embodiments. Further, at least one such multi-rate ONU has a maximum rate that is higher than the maximum rate of at least one other ONU on the same network 12, and the optical protocol used for the network 12 allows for different upstream transmission rates. As an example, for illustrative purposes it will be assumed hereafter unless otherwise indicated that the optical protocol used for the network is Higher Speed PON (HSP), also known as ITU-T G.9804.x, which allows upstream transmission rates of 12.5 Gbps, 25 Gbps, and 50 Gbps. Also assume for illustrative purposes that the ONU 21 is a multi-rate ONU capable of transmitting at any of the allowed rates and that the ONU 22 is configured to transmit only at 25 Gbps, which is lower than the maximum rate of the multi-rate ONU 21. In other embodiments, other optical protocols and upstream transmission rates and combinations of transmission rates are possible.

Note that, in the instant embodiment for which HSP is used, the OLT 15 may be configured to process messages that propagate at the highest data rate (i.e., 50 Gbps in the current example) using the equalizer 55 in order to compensate for transmission distortions, which may be caused by optical dispersion in the network 12. However, for messages transmitted at lower data rates (i.e., 12.5 Gbps or 25 Gbps) for which the transmission distortions are likely less, the OLT 15 may be configured to refrain from using the equalizer 55, thereby reducing the time and processing resources for processing such messages.

For illustrative purposes, assume that the ONU 23 is currently activated with the OLT 15 and that the ONUs 21-22 are currently unactivated. To enable activation of the ONUs 21-22, the OLT 15 is configured to initiate a discovery process that permits the unactivated ONUs 21-22 to communicate with the OLT 15 so that their presence on the network 12 can be discovered. As part of the discovery process, the OLT 15 defines a quiet window in which all activated ONUs 23 are prevented from communicating upstream. In this regard, the OLT 15 refrains from allocating any upstream timeslots to the activated ONUs 23 during the quiet window.

Further, near the time of the quiet window, the OLT 27 is configured to broadcast a message, referred to herein as a “discovery request,” that is received by the unactivated ONUs 21-22. In some embodiments, such discovery request includes control information specifying the data rate to be used by the unactivated ONUs 21-22 to respond to the discovery request. As an example, the discovery request may include a predefined identifier, referred to herein as an “allocation identifier (ID),” that identifies the upstream data rate permitted for a response to the discovery request in the quiet window.

In one embodiment, the OLT 15 defines the allocation ID to indicate a data rate of 25 Gbps, which is lower than the maximum data rate of 50 Gbps and also for which the equalizer 55 is not used for processing upstream messages as described above. Each unactivated ONU 21-22 that supports the specified rate (i.e., 25 Gbps in the current example) is configured to respond to the discovery request by transmitting to the OLT 15 a message, referred to herein as a “discovery response.” In the current example, assume that both unactivated ONUs 21-22 respond to the discovery request by transmitting a discovery response in the quiet window at the specified data rate of 25 Gbps, noting that the multi-rate ONU 21 is also capable of transmitting at a higher data rate (i.e., 50 Gbps) but nevertheless participates in the discovery process at the lower rate of 25 Gbps.

Further note that the messages communicated through the optical network 12, including in particular the discovery responses transmitted by the ONUs 21-23 during the discovery process, may be segmented to include a preamble 91 and a data portion 94 that are separated by a delimiter 99, as shown by FIG. 4. The preamble 91 may be a predefined string of values that enables the receiving device (e.g., OLT 15 for upstream communications) to recognize the start of the message, and the delimiter may be a predefined string of values that indicates the end of the preamble 91 and the beginning of the data portion 94. The data portion 94 may carry data to be processed. When transmitting a discovery response, each ONU 21-23 is configured to include within the data portion 94 of the message various information that may be used by the OLT 15 for activation of the ONU 21-23. As an example, the ONU 21-23 may transmit an identifier (e.g., a serial number) that uniquely identifies the ONU 21-23. The ONU 21-23 may also include information indicating the data rates that it supports. In some embodiments, such information is represented as a bit map, referred to hereafter as “rate map,” that includes a bit for each data rate associated with the optical protocol of the network 12, and each bit is set as appropriate to indicate whether the associated data rate is supported by the ONU 21-23. For example, in the current embodiment for which there are three possible data rates (i.e., 12.5 Gbps, 25 Gbps, and 50 Gbps), the rate map may include three bits that respectively represent the three possible data rates. In the current example for which ONU 22 supports only 25 Gbps and multi-rate ONU 21 supports all three data rates, the ONU 22 controls the rate map in its discovery response to indicate that only 25 Gbps is supported, whereas the multi-rate ONU 21 controls the rate map in its discovery response to indicate that all three data rates of the protocol are supported. In other embodiments, other techniques and formats for indicating the rates supported by the ONUs 21-23 are possible.

Upon receiving a discovery response, the controller 52 of the OLT 15 is configured to assign an ONU identifier to the ONU 21-23 that transmitted the discovery response and transmit the ONU identifier to the ONU 21-23 in a message, referred to herein as an “assignment notification.” Such an assignment notification is sometimes referred to as an “Assign ONU ID message.” Thereafter, the OLT 15 uses the assigned ONU identifier for communication with the ONU 21-23 over the network 12. As will be described in more detail below, the OLT 15 may also include information indicating the rate to be used by the ONU 21-23 for ranging.

Once the quiet window ends, the OLT 15 may have discovered one or more unactivated ONUs and assigned ONU identifiers to such ONUs. In the current example, assume that the OLT 15 has discovered the presence of and assigned ONU identifiers to the ONU 22 and the multi-rate ONU 21. For each discovered ONU 21-22, the OLT 15 then performs ranging with the respective ONU 21-22 to determine its round-trip transmission delay from the OLT 15. Such information may be used by the OLT in order to adjust the respective transmission timing of ONU 21 and ONU 22 in an effort to prevent overlapping upstream transmissions.

To perform ranging for a discovered ONU 21-22, the OLT 15 is configured to generate a separate quiet window for the purpose of ranging, referred to herein as a “ranging window”, for ONU 21 and for ONU 22. In this regard, for each upstream frame, the OLT 15 may be configured to broadcast a bandwidth map to all the ONUs 21-23 of the network 12 using a control channel defined by the optical protocol of the network 12. Such bandwidth map indicates each upstream timeslot that is allocated to each ONU 21-23 for the corresponding frame. That is, the bandwidth map defines upstream time slots in which the ONUs 21-23 are selectively permitted to transmit upstream. In the instant example, the OLT 15 allocates a timeslot for ONU 22 to transmit a ranging response within one ranging window and also allocates a timeslot for the multi-rate ONU 21 to transmit a ranging response within another ranging window such that each such ONU 21-22 may perform ranging with the OLT 15 free of interference from upstream transmissions by other ONUs of the network 12.

Note that the bandwidth map broadcast by the OLT 15 not only indicates how each timeslot is allocated, but it also associates each defined upstream transmission with information, referred to herein as a “burst profile index,” identifying the burst profile to be used in the associated transmission. Such burst profile index identifies the type and length of the preamble for messages transmitted in the window. Typically there are multiple burst profiles associated with each upstream rate. As an example, if a message to be transmitted is to be used to train the equalizer 55, the burst profile index for the transmission may indicate a preamble type associated with a relatively long preamble length sufficient for allowing training to successfully occur. However, if it is unnecessary to use a message for equalizer training, a burst profile index calling for a preamble of a shorter length may be used instead.

In some embodiments, for each ranging window, the controller 52 is configured to control the respective ONU to use the maximum data rate that is supported by both the OLT 15 and the ONU that is to communicate in the ranging window. In some embodiments, as briefly mentioned above, the information specifying the rate to be used in ranging may be carried by the assignment notification that is sent by the OLT 15 during discovery.

In this regard, as described above, the OLT 15 receives information indicative of the rates supported by an ONU 21-23 in the ONU's discovery response that is transmitted during discovery. Using this information from the ONU's discovery response, the controller 52 of the OLT 15 is configured to select the highest rate that is supported by both the ONU and the OLT 15 and include information indicating the selected rate in the assignment notification that is transmitted to the ONU subsequent to discovery. The ONU is configured then to transmit during ranging at the rate indicated in the assignment notification. In other embodiments, other techniques may be used to inform the ONU of which data rate to use during ranging.

In the instant example, for the ranging window to be used by the ONU 22, which only supports 25 Gbps, the OLT 15 defines the assignment notification transmitted to the ONU 22 subsequent to discovery to indicate a data rate of 25 Gbps, and based on such assignment notification, the ONU 22 is configured to transmit a message at 25 Gbps during its ranging window. As an example, the controller 52 may be configured to transmit to the ONU 22 a first ranging message, referred to hereafter as “ranging request,” which then responds by transmitting to the OLT 15 a second ranging message, referred to herein as “ranging response.” Using the ranging request and ranging response timing, the controller 52 may determine round-trip transmission delay between the ONU 22 and the OLT 15, and use that round-trip delay to adjust the timing of the transmissions of ONU 22 as is known in the art. In other embodiments, other techniques for performing the ranging process are possible.

As noted above, the maximum rate supported by the multi-rate ONU 21 is 50 Gbps. Thus, for the ranging window to be used by the multi-rate ONU 21, the OLT 15 defines the assignment notification transmitted to the multi-rate ONU 21 subsequent discovery to indicate a data rate of 50 Gbps, and based on such assignment notification, the multi-rate ONU 21 is configured to transmit a message at 50 Gbps during its ranging window. As an example, the same techniques described above for the ranging window used by the ONU 22 may be used in the ranging window with the multi-rate ONU 21 to determine the round-trip transmission delay between the multi-rate ONU 21 and the OLT 15.

Note that, since the multi-rate ONU 21 transmits a ranging message at a higher data rate (i.e., 50 Gbps in the current example), it may be desirable for the ranging message to be processed by the equalizer 55 at the OLT 15 in order to compensate for transmission distortions. Thus, the controller 52 may be configured to define the burst profile index for the ranging window of the multi-rate ONU 21 to indicate a different format for the message's preamble relative to the format indicated by the burst profile index for the ranging window of the ONU 22. For example, the preamble of the ranging message transmitted by the multi-rate ONU 21 may be longer than the preamble of the ranging message transmitted by the ONU 22, which transmits at a slower rate during its ranging window. Specifically, the preamble of the ranging message for the multi-rate ONU 21 may be sufficiently long to enable the equalizer 55 to train its coefficients by analyzing such preamble. Since the ONU 22 transmits its ranging message at a slower data rate (i.e., 25 Gbps in the current example), it is unnecessary for the equalizer 55 to process such ranging message, and its preamble thus may be shorter.

After ranging is performed, activation of the ONUs 21-22 is complete, and the controller 52 may allocate timeslots in the future to the ONUs 21-22 as may be desired for data communication. Unless the controller 52 sends an assignment notification with a different rate to ONUs 21-22, they will continue transmitting at the data rates used for ranging. Thus, subsequent to ranging in the current example, the ONU 22 may be controlled by the controller 52 to transmit upstream at 25 Gbps, and the multi-rate ONU 21 may be controlled by the controller 52 to transmit upstream at 50 Gbps, although other algorithms for selecting and using other data rates are possible.

As illustrated by the above example, a multi-rate ONU 21 may be controlled to transmit upstream in a discovery process at a data rate lower than the one ultimately to be used in later communications, including ranging. Notably, the multi-rate ONU 21 may participate in discovery during the same quiet window as other ONUs that are incapable of transmitting at the maximum possible rate (i.e., 50 Gbps in the current example) of the multi-rate ONU 21. In addition, by using a lower data rate during discovery, training of the equalizer 55 at the OLT 55 for compensating for distortions in the channel between the OLT 15 and the multi-rate ONU 21 may be delayed until after the discovery process so that the preamble of the messages transmitted by the multi-rate ONU 21 may be kept relatively short during discovery, thereby conserving time in the quiet window for other unactivated ONUs so that the risk of data collisions during discovery is reduced. Such equalizer training may be performed during a later window (such as during ranging) when timeslots have been allocated to the multi-rate ONU 21 such that data collisions are prevented via time-division multiplexing.

In some embodiments, the multi-rate ONU 21 may be configured to select its transmission power level (i.e., the output power of signals transmitted by the ONU 21) based on its data rate and/or the capabilities of the OLT 15. In this regard, applicable standards, such as HSP, often specify higher transmission power levels for higher data rates. For example, in HSP, a data rate of 25 Gbps is associated with a first transmission power level, and a data rate of 50 Gbps is associated with a second transmission power level that is higher than the first transmission power level. Typically, when an ONU is controlled to transmit at a certain data rate, it is configured to transmit using the transmission power level that is associated with such data rate by the standard.

As illustrated above, it is possible for a multi-rate ONU 21 to be controlled during discovery (or possibly at other times) to transmit at a lower data rate (e.g., 25 Gbps in the above example) than the highest data rate (e.g., 50 Gbps in the above example) supported by both the multi-rate ONU 21 and the OLT 15. In such an embodiment, the multi-rate ONU 21 may be configured to transmit at a lower transmission power level (e.g., the transmission power level specified for 25 G) in discovery and then transmit at a higher transmission power level (e.g., the transmission power level specified for 50 G) in ranging and thereafter. However, it is also possible for the multi-rate ONU 21 to be configured to infer the capabilities of the OLT 15, prior to discovery, for the purpose of determining whether a higher transmission power level during discovery is possible.

More specifically, prior to discovery, the multi-rate ONU 21 may be configured to analyze control information from the OLT 15 to determine whether the OLT 15 is capable of communicating at a higher rate than the one used by the multi-rate ONU 21 during discovery. As an example, in some embodiments, the OLT 15 may be configured to periodically transmit burst profile messages indicative of various information (e.g., burst profile parameters) about the burst profiles used for messages communicated through the optical network 12. Such information may be used by the ONUs 21-23 to determine how to format a message in accordance with a particular burst profile index. Each burst profile message is associated with a specific data rate and indicates the burst profile parameters for the burst profiles to be used with that data rate.

Notably, the OLT 15 may be configured to only send burst profile messages for data rates that are supported by the OLT 15. The multi-rate ONU 21 is configured to analyze the burst profile messages periodically broadcast by the OLT 15 to determine whether any such messages are associated with a higher data rate (e.g., 50 Gbps) than the one that it uses for discovery. If so, the multi-rate ONU 21 is aware that the OLT 15 supports the higher data rate and, thus, may safely select the transmission power level associated with such higher data rate when transmitting during discovery even though the multi-rate ONU 21 is controlled by the OLT 15 to actually transmit at a lower data rate during discovery.

As an example, assume that the multi-rate ONU 21 supports both 50 Gbps and 25 Gbps, as described above, and that the multi-rate ONU 21 is controlled to transmit at the lower data rate of 25 Gbps during discovery. Further, assume that the applicable protocol for the network 12 specifies a first transmission power level (referred to hereafter as “25 G power level”) for 25 Gbps and a second transmission power (referred to hereafter as “50 G power level”) for 50 Gbps.

In such example, prior to transmitting a discovery response during discovery, the multi-rate ONU 21 may analyze the burst profile messages broadcast by the OLT 15 to determine whether any such messages indicates a burst profile associated with the higher data rate of 50 Gbps. If so, the multi-rate ONU 21 is aware that the OLT 15 is compatible with a transmission level of 50 power level by the multi-rate ONU 21 even though it has actually been controlled to transmit at 25 Gbps during discovery using the techniques described above. In such case, the multi-rate ONU 21 may be configured to transmit the discovery response during the discovery quiet window at a data rate of 25 Gbps based on the discovery request transmitted by the OLT 15 but use the higher transmission power level of 50 G power level associated with the higher data rate of 50 Gbps. Using the higher transmission power level may improve the received signal quality of the discovery response without risking damage to the OLT 15 since it has been confirmed, based on the burst profile messages, to support 50 Gbps transmission and, thus, the 50 G power level associated with such higher data rate.

As briefly noted above, it should be emphasized that, in other embodiments, it is unnecessary for the multi-rate ONU 21 to transmit at a higher power level during discovery. As an example, when communicating at 25 G in discovery, the multi-rate ONU 21 may use a transmission power level of 25 G and then use the 50 G power level when it is switched to a data rate of 50 G according to the techniques described above.

Now, therefore, the following is claimed:

1. An optical network, comprising:
a plurality of optical network units (ONUs), including at least a multi-rate ONU configured to support both a first data rate and a second data rate compatible with an optical protocol for the optical network, wherein the first data rate is lower than the second data rate; and
an optical line terminal (OLT) optically coupled to each of the plurality of ONUs, the OLT configured to define a quiet window for ONU discovery and to transmit a first message having an allocation identifier that identifies the first data rate for the quiet window for ONU discovery, wherein the multi-rate ONU is configured to transmit, in response to the first message, a second message during the quiet window for ONU discovery at the first data rate based on the allocation identifier, wherein the OLT is configured to assign a network identifier to the multi-rate ONU in response to the second message, wherein the multi-rate ONU is configured perform a ranging process with the OLT subsequent to the quiet window for ONU discovery by transmitting a third message to the OLT, and wherein the OLT is configured to control the multi-rate ONU to transmit the third message at the second data rate.

2. The optical network of claim 1, wherein the OLT is configured to calculate a round-trip transmission delay between the multi-rate ONU and the OLT based on the third message.

3. The optical network of claim 1, wherein the OLT comprises an equalizer having a plurality of weighting coefficients, wherein the equalizer is configured to train the plurality of weighting coefficients based on a preamble of the third message.

4. The optical network of claim 3, wherein the preamble of the third message is longer than a preamble of the second message.

5. The optical network of claim 4, wherein the second message includes a serial number of the multi-rate ONU.

6. The optical network of claim 1, wherein the multi-rate ONU is configured to determine whether the OLT supports the second data rate based on a transmission from the OLT prior to the quiet window for ONU discovery, and wherein the multi-rate ONU is configured to transmit the second message at a transmission power level associated with the second data rate if the OLT is determined to support the second data rate.

7. The optical network of claim 1, wherein the OLT is configured to select the second data rate for use by the multi-rate ONU during the ranging process based on information in the second message.

8. The optical network of claim 7, wherein the information indicates a plurality of data rates supported by the multi-rate ONU.

9. An optical line terminal, comprising:
an optical transceiver optically coupled to a plurality of optical network units (ONUs), including at least a multi-rate ONU configured to support both a first data rate and a second data rate, wherein the first data rate is lower than the second data rate; and
a controller configured to transmit a first message having an allocation identifier that identifies the first data rate for use during ONU discovery, the controller further configured to receive during the ONU discovery a second message transmitted by the multi-rate ONU at the first data rate in response to the first message, wherein the controller is configured to perform a ranging process with the multi-rate ONU subsequent to the ONU discovery and to receive a third message from the multi-rate ONU during the ranging process, and wherein the OLT is configured to control the multi-rate ONU to transmit the third message at the second data rate.

10. The optical line terminal of claim 9, wherein the OLT is configured to assign a network identifier to the multi-rate ONU in response to the second message.

11. The optical line terminal of claim 9, wherein the controller is configured to calculate a round-trip transmission delay between the multi-rate ONU and the optical line terminal based on the third message.

12. The optical line terminal of claim 9, wherein the optical transceiver has an equalizer having a plurality of weighting coefficients, wherein the equalizer is configured to train the plurality of weighting coefficients based on a preamble of the third message.

13. The optical line terminal of claim 12, wherein the preamble of the third message is longer than a preamble of the second message.

14. The optical line terminal of claim 13, wherein the second message includes a serial number of the multi-rate ONU.

15. The optical line terminal of claim 9, wherein the controller is configured to select the second data rate for use by the multi-rate ONU during the ranging process based on information in the second message.

16. The optical line terminal of claim 15, wherein the information indicates a plurality of data rates supported by the multi-rate ONU.

17. A method for activating optical network units of an optical network, comprising:
communicating with a plurality of optical network units (ONUs) by an optical line terminal (OLT), the plurality of ONUs including at least a multi-rate ONU configured to support both a first data rate and a second data rate compatible with an optical protocol for the optical network, wherein the first data rate is lower than the second data rate;
defining, by the OLT, a quiet window for ONU discovery;
transmitting, by the OLT, a first message having an allocation identifier that identifies the first data rate for the quiet window for ONU discovery;
receiving, by the OLT during the quiet window for ONU discovery, a second message transmitted by the multi-rate ONU at the first data rate in response to the first message;
assigning, by the OLT, a network identifier to the multi-rate ONU in response to the second message;
performing, by the OLT, a ranging process with the multi-rate ONU subsequent to the quiet window for ONU discovery;
receiving, by the OLT during the ranging process, a third message transmitted from the multi-rate ONU; and
controlling, by the OLT, the multi-rate ONU to transmit the third message at the second data rate.

18. The method of claim 17, further comprising calculating, by the OLT, a round-trip transmission delay between the multi-rate ONU and the OLT based on the third message.

19. The method of claim 17, wherein the OLT comprises an equalizer having a plurality of weighting coefficients, wherein the method further comprises training the plurality of weighting coefficients based on a preamble of the third message.

20. The method of claim 19, wherein the preamble of the third message is longer than a preamble of the second message.

21. The method of claim 20, wherein the second message includes a serial number of the multi-rate ONU.

22. The method of claim 17, further comprising:
determining, by the multi-rate ONU, whether the OLT supports the second data rate based on a transmission from the OLT prior to the quiet window for ONU discovery; and
transmitting, by the multi-rate ONU, the second message at a transmission power level associated with the second data rate if the multi-rate ONU determines that the OLT supports the second data rate.

23. The method of claim 17, further comprising selecting, by the OLT, the second data rate for use by the multi-rate ONU during the ranging process based on information in the second message.

24. The method of claim 23, wherein the information indicates a plurality of data rates supported by the multi-rate ONU.
